(19) United States
(12) Patent Application Publication
(10) Pub. No.: US 2025/0075347 A1
(43) Pub. Date: Mar. 6, 2025

(54) BUNDLE ASSEMBLIES FOR USE IN ELECTROCHEMICAL CELL STACKS AND METHODS FOR USING THE SAME

(71) Applicant: Ohmium International, Inc., Newark, CA (US)

(72) Inventors: Arne Ballantine, Incline Village, NV (US); Jason Hixson, Soddy Daisy, TN (US); Chockkalingam Karuppaiah, Fremont, CA (US)

(21) Appl. No.: 18/823,605

(22) Filed: Sep. 3, 2024

Related U.S. Application Data
(60) Provisional application No. 63/536,233, filed on Sep. 1, 2023.
(60) Provisional application No. 63/646,417, filed on May 13, 2024.

(51) Int. Cl. C25B 9/70; C25B 9/65; H01M 8/2465

(52) U.S. Cl. CPC C25B 9/70; C25B 9/65; H01M 8/2465

(57) ABSTRACT

Electrochemical cell stacks that utilize a bundle assembly architecture to improve manufacturing, maintenance, and rework capabilities. Bundle assemblies include a top bundle plate, a bottom bundle plate, and a plurality of electrochemical cell layers disposed between the top bundle plate and the bottom bundle plate, and wherein the plurality of electrochemical cell layers is electrically and fluidly connected to the top bundle plate and the bottom bundle plate.

### CROSS-REFERENCE TO RELATED APPLICATIONS

This application claims priority to U.S. Provisional Application No. 63/536,233 titled “Bundle Stack Architecture with Edge Current Capability” filed Sep. 1, 2023, and to U.S. Provisional Application No. 63/646,417 titled “Bundle Stack Architecture with Edge Current Capability” filed May 13, 2024, the entire contents of each of which are incorporated by reference herein.

### FIELD OF THE DISCLOSURE

The present disclosure is directed to electrochemical cell stacks that include a bundle architecture that simplify rework and stack maintenance.

### BACKGROUND

Electrolyzer stacks are assembled in a series of repeating layers with all layers carrying equal current. Increasing stack size and cell quantity presents a challenge for manufacturing and field operations as each additional layer provides an opportunity for failures that limit the operation of the full stack. When failures occur, rework is often attempted; however, significant yield loss occurs as each layer must be decompressed and separated. In operation, electrochemical devices in series are generally limited by the weakest cell, which limits the stack's optimal operation and reduces stack life. In the case of weak cell performance, the entire stack must be regulated by either reducing the total amount of DC current or allowing higher voltage, both of which impact performance.

Prior designs to address manufacturing risks were focused on separating larger stacks into multiple stacks with reduced stack layers. This results in duplication of hardware and has limited practicality as the additional hardware costs and space limitations generally constrain the size of the stack. To address failure modes while maintaining stack output, designs attempted to short an individual weak cell, which is challenging due to high current and limited accessibility. Functionality was limited to only bypassing the cell which removed all electrochemical activity. Rework often required decompression and disassembly, which introduced new failure modes to previously healthy cells.

### SUMMARY

Provided herein are electrochemical cell stacks for use in generating hydrogen, fuel cells, or electrochemical compression, having a bundle assembly architecture to provide better rework and maintenance practices. The electrochemical cell stacks include: a first end cap assembly; a plurality of bundle assemblies, each bundle assembly including: a top bundle plate, a bottom bundle plate, and a plurality of electrochemical cell layers disposed between the top bundle plate and the bottom bundle plate; and a second end cap assembly. The plurality of electrochemical cell layers is electrically and fluidly connected to the top bundle plate and the bottom bundle plate. The plurality of bundle assemblies is disposed between the first end cap assembly and the second end cap assembly. The plurality of bundle assemblies is electrically and fluidly connected to the first end cap assembly and the second end cap assembly.

Further provided herein is a bundle assembly for use in an electrochemical cell stack as described herein. The bundle assembly includes a top bundle plate, a bottom bundle plate, and a plurality of electrochemical cell layers disposed between the top bundle plate and the bottom bundle plate. The plurality of electrochemical cell layers is electrically and fluidly connected to the top bundle plate and the bottom bundle plate.

Further provided herein is a process for manufacturing an electrochemical cell stack. The processes generally include manufacturing a bundle assembly of the present disclosure and fluidly and electrically connecting two or more bundle assemblies to form the electrochemical cell stack.

### BRIEF DESCRIPTION OF THE FIGURES

The present disclosure may be understood by reference to the following detailed description taken in conjunction with the drawings briefly described below. It is noted that, for purposes of illustrative clarity, certain elements in the drawings may not be drawn to scale. System components such as valves, sensors, and the like are not shown for the purposes of clarity, but those having ordinary skill in the art will appreciate that such components may be present in the systems described herein.

FIG. 1A shows a diagram of an electrochemical cell stack of the present disclosure. FIG. 1B shows a figure of an example electrochemical cell stack of the present disclosure.

FIG. 2 shows an example of a bundle assembly of the present disclosure.

FIG. 3A shows an example of a bundle assembly with plenum hydration plugs installed. FIG. 3B shows an example of a plenum hydration plug.

FIG. 4A shows an example of a latch used to provide a compressive force to a bundle assembly of the present disclosure. FIG. 4B shows the latch of FIG. 4A installed on a bundle assembly.

FIG. 5 shows an example of two bundle assemblies, wherein one of the bundle assemblies includes edge current carrying features.

FIG. 6A shows an example of an electrochemical cell stack of the present disclosure including a bypass circuit using Zener diodes. FIG. 6B shows an example of an electrochemical cell stack of the present disclosure including a bypass circuit using a DC/DC controller.

### DETAILED DESCRIPTION

The present disclosure is directed to electrochemical cell stacks including a novel bundle architecture that simplifies rework and maintenance of the stack. Each electrochemical cell stack includes a plurality of bundle assemblies, and each bundle assembly includes a plurality of electrochemical cell layers. Accordingly, the bundle architecture creates a modular stack assembly. Each of the electrochemical cell layers in the bundle assemblies includes traditional electrochemical stack design elements such as membrane layers, electrode layers, diffusion layers, bipolar/monopolar flow field plates, etc. In a manufacturing environment, the features of the electrochemical cell stacks described herein allow the manufacture and alignment of bundles enabling standardized work scope. This includes the ability to complete manufacture of the bundles followed by compression, functional testing, and hydration at the bundle assembly level, rather than manufacturing an entire electrochemical cell stack before conducting any testing.

Electrolyzers require hydration and activation to ensure stacks remain wet prior, during, and after operation to avoid damaging the membrane. The testing processes vary, but generally is done at a stack level, which can create delays in stack conditioning and testing. The bundle assembly provides the option to hydrate and plug water plenums to maintain hydration during manufacturing and rework operations, avoiding the risk of further failures. This can be further extended to functional testing. The ability to seal off a bundle assembly through the use of mechanical plugs allows the bundle to proceed with electrical and mechanical testing under fully hydrated conditions, which can vary from dry conditions. Once a stack is hydrated, the associated membrane expansion and shrinkage can lead to failures. By providing compression forces through each bundle assembly and throughout the electrochemical cell stack, this mode of failure may be avoided.

The modularity of the system also enables replacement and/or repair of the bundle assembly in any location, including the manufacturing facility, at the location of the consumer, or at an offsite location.

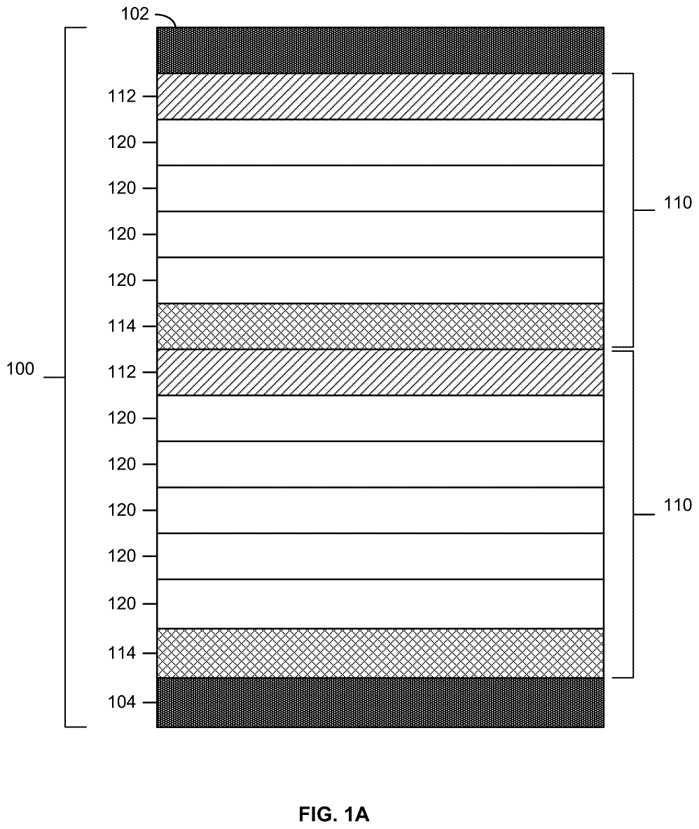

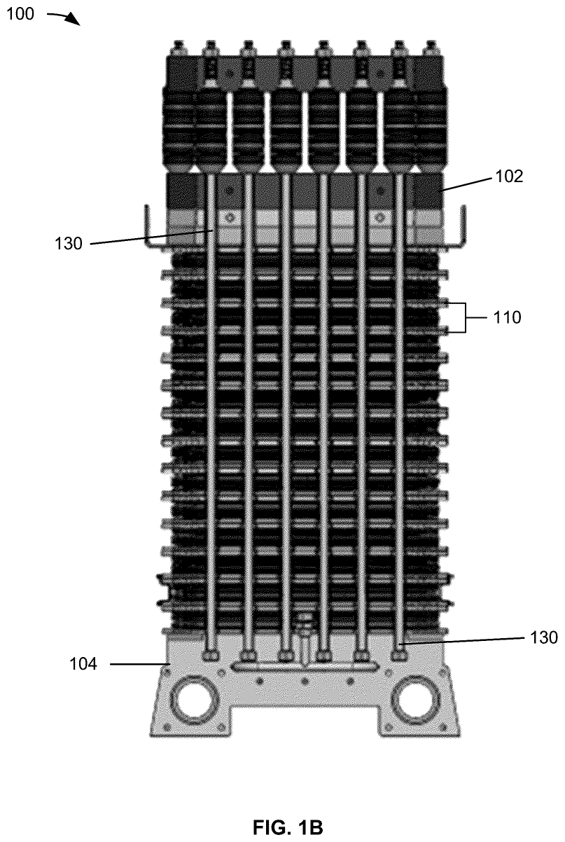

Referring to FIG. 1A, the electrochemical cell stack 100 of the present disclosure includes a first end cap assembly 102, a second end cap assembly 104, and a plurality of bundle assemblies 110 disposed between the first end cap assembly 102 and the second end cap assembly 104. Each bundle assembly 110 is fluidly and electrically connected to the bundle assembly (or bundle assemblies) adjacent thereto. The first end cap assembly 102 is fluidly and electrically connected to the bundle assembly 110 adjacent thereto. The second end cap assembly 104 is fluidly and electrically connected to the bundle assembly 110 adjacent thereto. The fluid connections connecting the first end cap assembly 102, the second end cap assembly 104, and the plurality of bundle assemblies 110 may connections to transfer liquid, gas, or a combination thereof throughout the electrochemical cell stack 100. In the case of electrolysis to produce hydrogen, the fluid connections may include pipes to transfer water, hydrogen, and oxygen to and from the electrochemical cell stack 100. FIG. 1B shows a picture of an example electrochemical cell stack 100 of the present disclosure.

The electrochemical cell stack 100 may be configured for use as an electrolyzer stack, a fuel cell stack, or an electrochemical compression cell stack. Each of the bundle assemblies 110 may also be configured for any one of these purposes, as described further below.

The first end cap assembly 102 and the second end cap assembly 104 each include electrical, fluid, and mechanical connection points to connect to a bundle assembly 110. The fluid connections each include seals to prevent leaks. The end cap assemblies each include piping to provide and/or remove fluid from the electrochemical cell stack 100. The end cap assemblies also include electrical circuitry to provide and regulate electricity in the electrochemical cell stack 100.

The first end cap assembly 102 and the second end cap assembly 104 each further include loading hardware. The loading hardware applies a compression force throughout the electrochemical cell stack 100. The loading hardware may include tie rods, Belleville washers, spring mechanisms (e.g., leaf spring), a gas-filled bladder to adjust compression, or other mechanisms to provide a compressive force through the stack. As an example, the electrochemical cell stack shown in FIG. 1B shows tie rods 130 used to apply a compressive force.

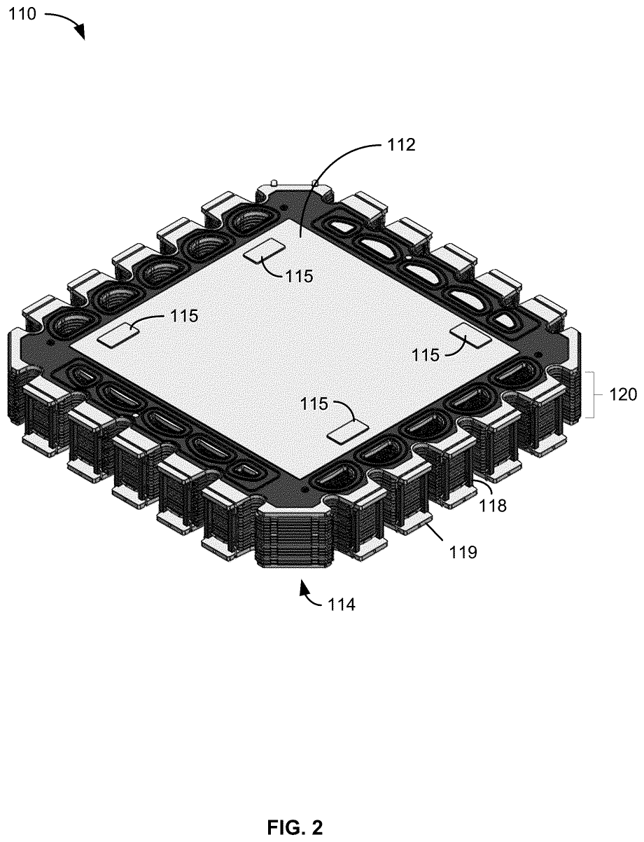

Each of the first end cap assembly 102 and the second end cap assembly 104 may include alignment features 115 to properly align with a bundle assembly 110 when installed (see FIG. 2). The alignment features 115 may include dowels, pins, guide rails and channels, edge guides and stops, snap hooks, latches, cam locks, tapered features, interlocking features, visual alignment marks, and others known in the art. The alignment features are preferably made from dielectric materials to prevent current from passing through.

Each bundle assembly 110 includes a top bundle plate 112, a bottom bundle plate 114, and a plurality of electrochemical cell layers 120. An example of a bundle assembly for use in the apparatuses of the present disclosure is shown in FIG. 2. Each of the electrochemical cell layers 120 operates as an electrochemical cell and may carry equal current. Electrochemical cell layers and methods of making the same are generally known to those having ordinary skill in the art. Generally, each electrochemical cell layer 120 may be identical to the others in the electrochemical cell stack 100.

Each electrochemical cell layer 120 includes a membrane electrode assembly comprising an anode, a cathode, and an ion exchange membrane disposed between the anode and the cathode. Membrane electrode assemblies and methods for making and procuring the same are generally known in the art. The ion exchange membrane may be a proton exchange membrane, an anion exchange membrane, a membrane suitable for alkaline electrolysis, or a membrane suitable for solid oxide electrolysis. Membranes of these types are generally known in the art. The anode may comprise an anode catalyst contacting the membrane and an optional anode fluid diffusion layer. The cathode may comprise a cathode catalyst contacting the membrane and an optional cathode gas diffusion layer. The anode may comprise any suitable anode catalyst, such as an iridium layer. The anode gas diffusion layer may comprise a porous material, mesh, or weave, such as a porous titanium sheet or a porous carbon sheet. The cathode may comprise any suitable cathode catalyst, such as a platinum layer. The cathode gas diffusion layer may comprise porous carbon. Other noble metal catalyst layers may also be used for the anode and/or cathode electrodes. The anode may be oriented toward the top of the electrochemical cell stack with respect to the cathode, or the anode may be oriented toward the bottom of the electrochemical cell stack with respect to the cathode. Each electrochemical cell layer 120 is electrically isolated, having only a central active area being electrically conductive through the electrochemical cell stack 100. The membrane electrode assembly may have a thickness from about 80 microns to about 180 microns.

The electrochemical cell layer 120 may further comprise a gas diffusion layer on both the anode side and on the cathode side of the membrane electrode assembly. The gas diffusion layers help distribute gases along the surface of the electrodes in each cell. The gas diffusion layer may comprise a porous sheet. The porous sheet may comprise metals such as titanium or carbon. The gas diffusion layer is disposed on the outside of the cathode and anode layers of the cell; i.e., between the anode layer and the bipolar plate, and between the cathode layer and the bipolar plate.

The electrochemical cell layer 120 may further comprise a top bipolar plate disposed between adjacent to an electrochemical cell layer 120 or the bundle top plate 112 of the bundle assembly 110, and a bottom bipolar plate disposed adjacent to electrochemical cell layer 120 or the bundle bottom plate 114 of the electrochemical cell layer 110. Each bipolar plate includes a substrate, a top gasket, and a bottom gasket. The gaskets provide a seal around the active areas of the anode or cathode (i.e., flow fields).

The substrate may be formed of any one or more of various different types of materials that are electrically conductive, thermally conductive, and have strength suitable for withstanding the high pressure of hydrogen flowing along the cathode side of the substrate during use. Thus, for example, the substrate may be at least partially formed of one or more of plasticized graphite or carbon composite. Further, or instead, the substrate may be advantageously formed of one or more materials suitable for withstanding prolonged exposure to water on the anode side of the substrate. Accordingly, in some instances, the anode side of the substrate may include an oxidation inhibitor coating that is electrically conductive, examples of which include titanium, titanium oxide, titanium nitride, or a combination thereof. The oxidation inhibitor may generally extend at least along those portions of the anode side of the substrate exposed to water during operation of the electrochemical cell stack. That is, the oxidation inhibitor may extend at least along the anode flow field inside the anode gasket on the anode side of the substrate. In some implementations, the oxide inhibitor may extend along a plurality of anode ports (i.e., water riser openings) which extend from the anode side to the cathode side of the substrate. The oxidation inhibitor may also be located in the anode plenums which connect the anode portions to the anode flow field on the anode side of the substrate.

The electrochemical cell layer 120 may further comprise a top support plate disposed between adjacent to an electrochemical cell layer 120 or the bundle top plate 112 of the bundle assembly 110, and a bottom support plate disposed adjacent to electrochemical cell layer 120 or the bundle bottom plate 114 of the electrochemical cell layer 120. The support plates are preferably placed on the outside of the bipolar plates when included. The support plates include openings for liquids and gases to flow through the electrochemical cell stack to the active areas of the electrochemical cell layers 120. The support plate provides strength to the electrochemical cell layer when held under compression. The top bundle plate 112 and the bottom bundle plate 114 of each bundle assembly 110 are points of separation where the bundle assembly 110 may be removed from the electrochemical cell stack 100.

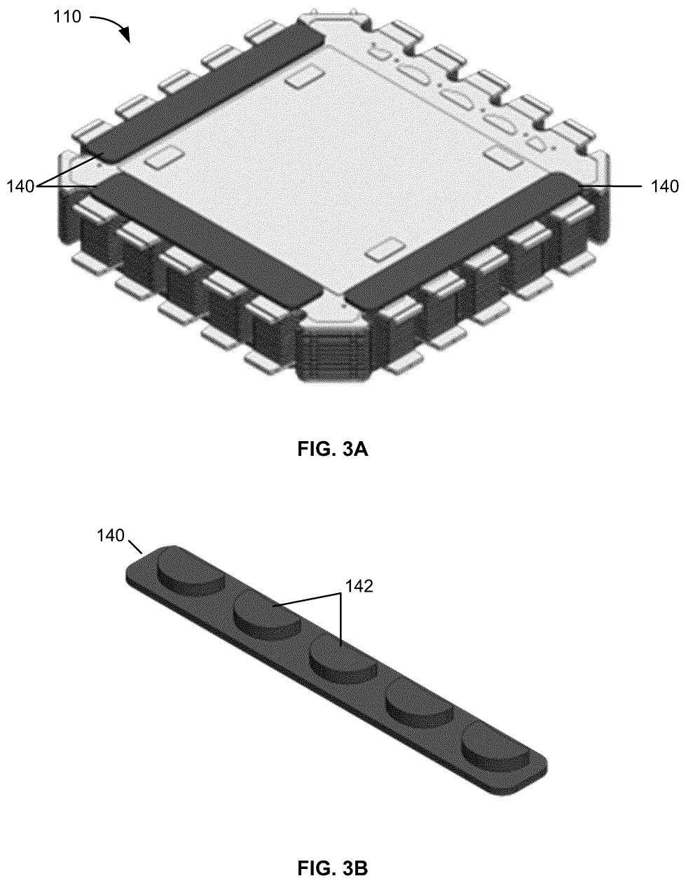

The electrochemical cell layer 120 may further comprise one or more seals or plenum hydration plugs 140. An example bundle assembly including the plenum hydration plugs installed is shown in FIG. 3A. The seals and plenum hydration plugs 140 provide a barrier around the fluid connections of the electrochemical cell layer 120 to prevent leaks, maintain proper levels of humidity within the electrochemical cell layer, and to maintain health of the electrochemical cell layer. An example of a plenum hydration plug is shown in FIG. 3B. The seals and plenum hydration plugs 140 may comprise rubber or another water-impermeable material to seal off water and hydrogen plenums, thereby retaining moisture in the electrochemical cell layers. As shown in FIG. 3B, the plenum hydration plugs may comprise raised areas 142 that form a friction fit in the plenums of the bundle assembly to create a seal. Preferably, the seals and plenum hydration plugs 140 may be made from a dielectric material to prevent current flowing through the seals and plenum hydration plugs.

Although FIG. 1A shows that each bundle assembly 110 includes four electrochemical cell layers 120 or five electrochemical cell layers 120, each bundle assembly 110 may include two or more electrochemical cell layers. For example, each bundle assembly may include two, three, four, five, six, seven, eight, nine, ten, fifteen, twenty, twenty-five, thirty, or more electrochemical cell layers.

The top bundle plate 112 of each bundle assembly 110 is disposed adjacent to an electrochemical cell layer 120 and either a bottom bundle plate 114 of an adjacent bundle assembly 110 or a first end cap assembly 102 of the electrochemical cell stack 100. The top bundle plate 112 is fluidly and electrically connected to the adjacent electrochemical cell layer 120 and to the adjacent bottom bundle plate 114 or to the adjacent first end cap assembly 102. The top bundle plate 102 may have a thickness such that the top bundle plate is capable of carrying a current around the perimeter of the plate. For example, the top bundle plate 102 may have a thickness on the order of 1-50 mm.

The top bundle plate 112 comprises a metal substrate that is electrically and thermally conductive, while also being mechanically strong to prevent deflection. For example, the top bundle plate may be made of stainless steel. The top bundle plate includes electrical, fluid, and mechanical connection points to securely attach to and complete electrical and fluid connections to the first end cap assembly 102 or to the bottom bundle plate 114 of an adjacent bundle assembly 110. Each fluid connection point includes seals to prevent leaks.

The top bundle plate 112 includes one or more alignment features to help align the top bundle plate 112 to be in a correct position with an adjacent bottom bundle plate 114 or with a first end cap assembly 102. The alignment features may include pins and holes, guide rails and channels, edge guides and stops, snap hooks, latches, cam locks, tapered features, interlocking features, visual alignment marks, and others known in the art. The alignment features are preferably made from dielectric materials to prevent current from passing through.

In some embodiments, the top-most top bundle plate may be plugged so that no fluid flows from the top bundle plate into the first end cap assembly. In such embodiments, the first end cap assembly does not require plumbing to transfer fluids to or from the electrochemical cell stack. However, in other embodiments, the top-most bundle plate may not be plugged and the first end cap assembly may include plumbing to transfer fluid to and from the electrochemical cell stack.

The bottom bundle plate 114 is disposed adjacent to an electrochemical cell layer 120 and either a top bundle plate 112 of an adjacent bundle assembly or a second end cap assembly 104 of the electrochemical cell stack. The bottom bundle plate 114 is fluidly and electrically connected to the adjacent electrochemical cell layer 120 and to the adjacent top bundle plate 112 or to the adjacent second end cap assembly 104. The bottom bundle plate 104 may have a thickness such that the bottom bundle plate is capable of carrying a current around the perimeter of the plate. For example, the bottom bundle plate 104 may have a thickness on the order of 1-50 mm.

The bottom bundle plate 114 comprises a metal substrate that is electrically and thermally conductive, while also being mechanically strong to prevent deflection. For example, the bottom bundle plate may be made of stainless steel. The bottom bundle plate includes electrical, fluid, and mechanical connection points to securely attach to and complete electrical and fluid connections to the second end cap assembly 104 or to the top bundle plate 112 of an adjacent bundle assembly 110. Each fluid connection point includes seals to prevent leaks.

The bottom bundle plate 114 includes one or more alignment features to help align the bottom bundle plate 114 to be in a correct position with an adjacent top bundle plate 112 or with a second end cap assembly 104. The alignment features may include pins and holes, guide rails and channels, edge guides and stops, snap hooks, latches, cam locks, tapered features, interlocking features, visual alignment marks, and others known in the art. The alignment features are preferably made from dielectric materials to prevent current from passing through.

The top bundle plate 112 and the bottom bundle plate 114 further provide a protective feature within the stack to avoid cascading failures. For example, when a cell failure occurs, high localized current densities that would otherwise develop across the electrochemical cell layers may be redistributed at the interface of two adjacent bundle assemblies. This occurs due to good lateral electrical conductivity across the interface between the bundle assemblies. The lateral conductivity is attributed to material properties of the bundle plates based on their composition. For example, stainless steel provides good lateral conductivity for this purpose. This protects failures from propagating through the entire electrochemical cell stack.

Each bundle assembly 110 in the electrochemical cell stack 100 is fluidly and electrically connected to adjacent bundle assemblies. Additionally, the top-most bundle assembly is fluidly and electrically connected to the first end cap assembly, and the bottom-most bundle assembly is fluidly and electrically connected to the second end cap assembly. By this arrangement, electricity flows via the electrical connections in the first end cap assembly 102, the plurality of bundle assemblies 110, and the second end cap assembly 104, from the first end cap assembly 102 through each of the plurality of bundle assemblies 110 to the second end cap assembly 104, or from the second end cap assembly 104 through each of the plurality of bundle assemblies 110 to the first end cap assembly 102. Additionally, water and/or gases such as hydrogen and oxygen are able to flow through each bundle assembly 110 to the electrochemical cell layers 120 within each bundle assembly via the fluid connections in each bundle assembly 110 and in the first end cap assembly 102 and the second end cap assembly 104. The water and/or other gases are also able to flow from the second end cap assembly 104 to the first end cap assembly 102, or from the first end cap assembly 102 through each of the plurality of bundle assemblies to the second end cap assembly 104.

Although not shown in FIG. 1A, a gasket may be included between one or more layers of the electrochemical cell stack 100 to further ensure a fluid-tight seal. In particular, a gasket may be placed between each bundle assembly 110 in the electrochemical cell stack 100.

While FIG. 1A shows an electrochemical cell stack including only two bundle assemblies, it will be appreciated that the electrochemical cell stacks of the present disclosure may include any number of bundle assemblies. For example, the electrochemical cell stacks of the present disclosure may include two, three, four, five, six, seven, eight, nine, ten, fifteen, twenty, or more than twenty bundle assemblies.

Each bundle assembly 110 includes one or more latching features 118 to secure the bundle assembly 110 in place in the electrochemical cell stack 100 and to keep the bundle assembly under compression during testing before the bundle assembly 110 is installed in the electrochemical cell stack 100 and during operation. The latching features 118 provide compression through the bundle assembly by applying and maintaining a compressive force between the top bundle plate 112 and the bottom bundle plate 114. The latching features 118 may be reversibly attachable to the top bundle plate 112 and to the bottom bundle plate 114. The latching features provide a mechanical interlock so that a latch may be connected to the top bundle plate and bottom bundle plate to provide the compressive force. The top bundle plate 112 and the bottom bundle plate 114 may include machined grooves 119 where the latch may reversibly attach. The latching features 118 are preferably made from dielectric materials to prevent electrical current from passing around the bundle assembly 110. The latching features 118 may include a hook and loop system, a nut-and-bolt system, a cam latch, a toggle latch, a rotary latch, or other latching systems known in the art. In an embodiment, the latching feature 118 includes an elastic strap secured to the bundle assembly with metal strips that compresses the layers of the bundle assembly.

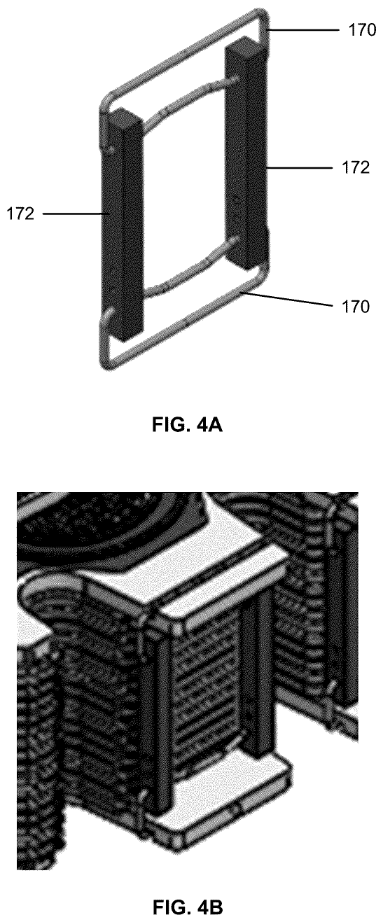

FIGS. 4A and 4B show an example latching feature 118. The latching feature includes metal clips 170 and elastic bands 172. The metal clips are configured to reversibly engage with machined grooves 119 on the bundle assembly 110. The elastic bands 172 provide the compression forces to the bundle assembly 110. The elastic bands 172 are preferably made from a dielectric material to prevent current from flowing across the bands.

The bundle assembly 110 may further include one or more stiffening elements to redistribute the compressive load to an adjacent bundle assembly, to the first end cap assembly 102, or the second end cap assembly 104 to minimize deflection throughout the stack. The stiffening elements may be placed on the top bundle plate 112 or the bottom bundle plate 114. The stiffening elements may include shims or geometric features that focus the load on a preferred area of the bundle assembly 110. For example, the stiffening elements may focus the load on the active area of the electrochemical cell stack 100 to ensure good interlayer contact between each bundle assembly. Alternatively, the stiffening elements may focus the load around sealing areas of the bundle assembly 110 to prevent leaks.

The bundle assembly 110 may further include one or more draining features. The draining feature may include a port to open and allow excess water to drain from the bundle assembly prior to rework and maintenance. The port may be located on the top bundle plate 112 or on the bottom bundle plate 114.

The bundle assembly 110 may further include one or more venting features. The venting features may include a vent to release excess gas in the bundle assembly prior to rework or maintenance. The venting feature may be a simple pressure release valve to release the excess gas. Additionally, the venting feature may allow for sampling of gases to determine the composition of the gas trapped in the bundle assembly.

Manufacturing the bundle assemblies in this way enables completion of the bundle assembly followed by compression testing, functional testing, and hydration at the bundle assembly level before the entire electrochemical cell stack is manufactured. Compression testing includes the mechanical latching via the latching features of the top bundle plate and bottom bundle plate to apply a mechanical load to the bundle assembly to prevent movement of the interlayer components. This is then followed by functional testing, which may include electrical testing and mechanical testing. A final test may also include fully hydrating the bundle assembly with humid hydrogen and/or water.

The bundle latching features also allow for stack rework in the event of sub-optimal performance. Disassembling each layer of a stack to repair a single cell failure can be challenging after hydrating the stack. Each decompression and layer by layer separation creates additional risk of failure. By bundling the stacks, all known good bundle assemblies can remain under compression and undisturbed during rework. With natural separation points at the interface between each bundle assembly, the bundle assembly with a known cell failure can be removed and undergo disassembly. This improves end to end yield in the factory and allow more standardized rework processes.

The rework process generally includes decompressing the electrochemical cell stack, removing one or more bundle assemblies from the electrochemical cell stack, conducting electrical tests to identify where the cell failure or reduced performance is located, and replacing the bundle assemblies that are determined to have cell failure or reduced performance with new bundle assemblies. The decompression occurs by decompressing and removing the loading hardware on each of the first end cap assembly 102 and the second end cap assembly 104. The electrical testing may include measuring the capacitance and impedance of the bundle assembly.

The series architecture of the electrochemical cell stack limits the capabilities of the stack by the weakest cell, which can prohibit optimal operation of the stack. If cell performance is weak, the entire stack must be regulated by reducing the total amount of DC current, which reduces stack performance and reduces the life of the stack.

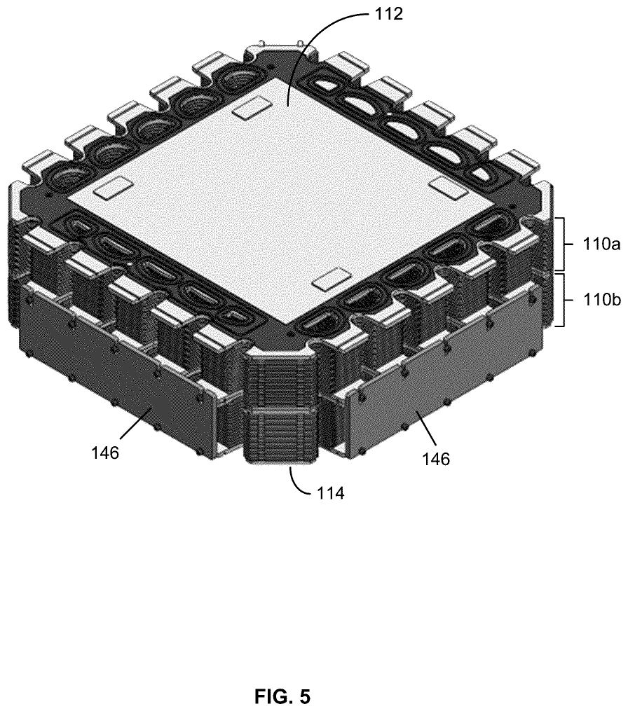

To combat this, the bundle assembly may further include edge current carrying features 146 such as shown in FIG. 5, which shows two bundle assemblies 110a, 110b, wherein the lower bundle assembly 110b includes edge current carrying features. This enables decoupling the bundle assembly 110b by bypassing current in the case of sub-optimal performance, thereby improving stack performance and extending the life of the stack. The edge current carrying features 146 are physical connection points that allow current to travel to the outer perimeter of the bundle assembly 110b. The edge current carrying features may be attached to the top bundle plate 112 or, as shown in FIG. 5, to the bottom bundle plate 114 of the bundle assembly 110b. The edge current carrying features 144 are made from materials capable of safely carrying high amounts of DC current. In an embodiment, the edge current carrying feature may include a busbar. The busbar may be mechanically attached to the edge current carrying features 146 to bypass the bundle assembly 110b. The busbar preferably has a lower electrical resistance than the bundle assembly 110b to enable electrical current to bypass the electrochemical cell layers. To enable the use of the edge current carrying features 146, the top bundle plate 112 and the bottom bundle plate 114 must be of sufficient thickness and conductivity to carry the current along the perimeter of the plates.

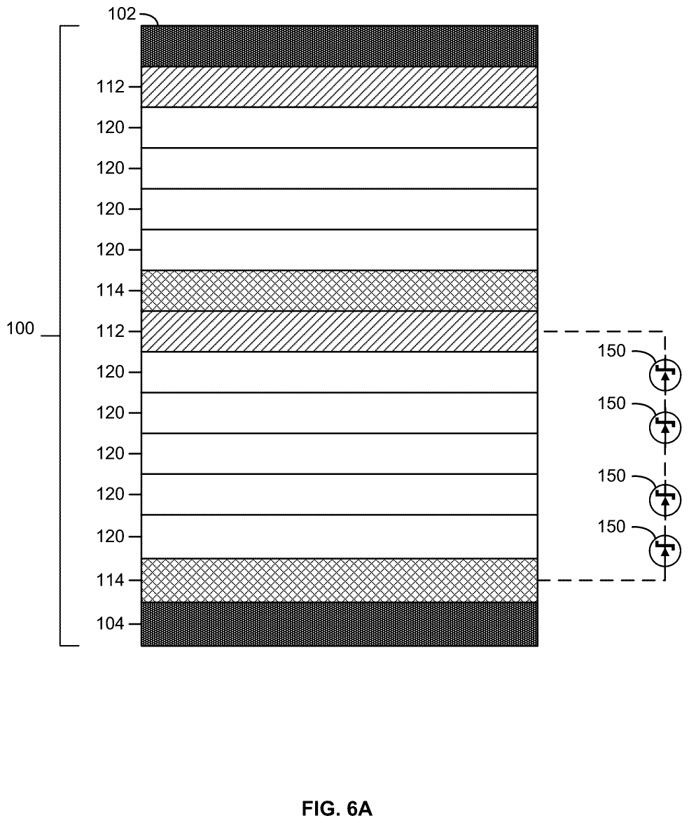

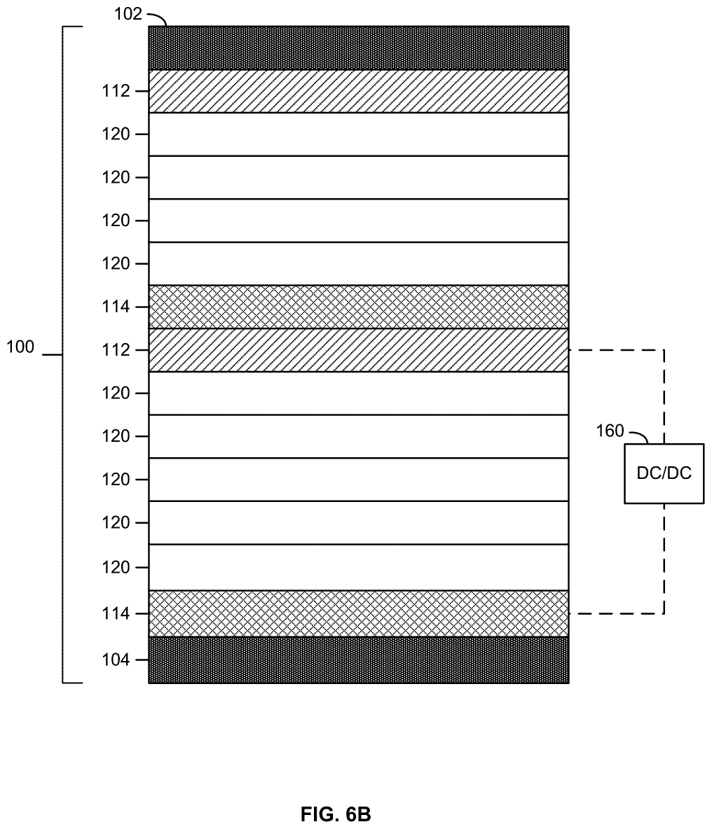

The edge current carried by the edge current carrying features 144 may be controlled by DC electronics or by an external control system. This helps to optimize the current pushed through the bundle assembly to further improve life and performance. The DC electronics may include a tubule electronic load that diverts part of the edge current from one or more bundle assemblies through the DC electronics system, thereby regulating the current along one or more edges of the one or more bundle assemblies. The DC electronics system may be housed in either the first end cap assembly, the second end cap assembly, or externally from the electrochemical cell stack. The DC electronics are electrically connected to one or more bundle assemblies in the plurality of bundle assemblies in the electrochemical cell stack. In another embodiment, as shown in FIG. 6A, one or more Zener diodes 150 may be used to regulate the current across the bundle assembly. Although four Zener diodes are shown in FIG. 6A, any number of Zener diodes may be used to control the current being bypassed. In another embodiment, as shown in FIG. 6B, the edge current may be regulated through an individual DC/DC control system 160.

Further provided herein are processes for building an electrochemical cell stack of the present disclosure. The methods generally include building a bundle assembly as described herein by providing a bottom bundle plate; connecting a plurality of electrochemical cell layers on top of the bundle plate; and connecting a top bundle plate to the top-most electrochemical cell layer in the plurality of electrochemical cell layers. This process includes fluidly, electrically, and mechanically connecting each of the bottom bundle plate, the plurality of electrochemical cell layers, and the top bundle plate. Preferably, each of the layers is prefabricated so that electrical and fluid connections may be made between each layer by simply stacking the layers together. The plurality of electrochemical cell layers may be added in a single step, or each electrochemical cell layer may be added one-by-one to the bundle assembly.

The method then proceeds by compressing the bundle assembly. The compression may be achieved by, for example, a hydraulic press to compress the layers of the bundle assembly. A latch may then be applied to latching features located on the top bundle plate and bottom bundle plate as described above to maintain the compression on the bundle assembly. Once the latch is in place, the active compression may stop, and the latch will continue to maintain the compressive forces on the bundle assembly. Generally, the compressive forces acting on the bundle assembly are much greater than the weight of the bundle assembly itself.

The bundle assembly may then undergo testing before it is installed into an electrochemical cell stack. The testing may include mechanical testing, leak testing, or functional testing such as electrical testing (e.g., testing for impedance and capacitance), and combinations thereof. By testing the bundle assembly prior to installation in the electrochemical cell stack, potential problems can be addressed sooner. Testing methods useful for these purposes are generally known to those having ordinary skill in the art.

The method may also include hydration of the bundle assemblies after testing to begin hydration of the electrochemical cell layer elements. This step is optional but is preferred to prepare the bundle assemblies for use. The hydration may comprise simply pumping water into the fluid connections of the bundle assembly prior to installing the bundle assembly in the electrochemical cell stack. In an embodiment, multiple bundle assemblies may be stacked and attached with one another while submerged under water to ensure complete hydration of the bundle assemblies.

Once the bundle assembly has been tested, it may be installed in the electrochemical cell stack. This process is then repeated until all bundle assemblies are installed in the electrochemical cell stack. Alignment features on each bundle assembly and/or on the end cap assemblies of the electrochemical stack may be used to ensure proper placement of the bundle assemblies in the electrochemical cell stack. As described herein, the bundles are independently removable from the electrochemical cell stack.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity and in another example, a numerical range of “about 50 mg/mL to about 80 mg/mL” should also be understood to provide support for the range of “50 mg/mL to 80 mg/mL.”

As used herein, the terms “including,” “containing,” and/or “having” are understood to mean comprising and are open ended terms.

The indefinite articles “a” and “an,” as used herein in the specification and in the claims, unless clearly indicated to the contrary, should be understood to mean “at least one.”

Although terms such as “top” and “bottom” are used throughout, these are intended to be relative terms and are solely used for the purpose of illustration. Embodiments of the apparatuses described herein may be oriented in a horizontal plane.

### ENUMERATED EMBODIMENTS

Embodiment 1: An electrochemical cell stack comprising:
a first end cap assembly;
a plurality of bundle assemblies, each bundle assembly including:
   a top bundle plate,
   a bottom bundle plate, and
   a plurality of electrochemical cell layers disposed between the top bundle plate and the bottom bundle plate, and
   wherein the plurality of electrochemical cell layers is electrically and fluidly connected to the top bundle plate and the bottom bundle plate; and
a second end cap assembly,
wherein the plurality of bundle assemblies is disposed between the first end cap assembly and the second end cap assembly, and
wherein the plurality of bundle assemblies is electrically and fluidly connected to the first end cap assembly and the second end cap assembly.

Embodiment 2: The electrochemical cell stack of embodiment 1, wherein each bundle assembly in the plurality of electrochemical cell layers is independently removable from the electrochemical cell stack.

Embodiment 3: The electrochemical cell stack of embodiment 2, wherein each electrochemical cell layer is electrically isolated.

Embodiment 4: The electrochemical cell stack of any one of embodiments 1-3, wherein each electrochemical cell layer includes a proton exchange membrane, an anion exchange membrane, a membrane for alkaline electrolysis, or a membrane for solid oxide electrolysis.

Embodiment 5: The electrochemical cell stack of any one of embodiments 1-4, further comprising one or more compression features attached to the first end cap assembly and the second end cap assembly to hold the electrochemical cell stack under compression.

Embodiment 6: The electrochemical cell stack of embodiment 5, wherein the compression features include tie rods.

Embodiment 7: The electrochemical cell stack of any one of embodiments 1-6, wherein each top bundle plate and each bottom bundle plate further include one or more alignment features to align the bundle assembly in the electrochemical cell stack.

Embodiment 8: The electrochemical cell stack of any one of embodiments 1-7, wherein the electrochemical cell stack is an electrolyzer stack, a fuel cell stack, or an electrochemical compression cell stack.

Embodiment 9: The electrochemical cell stack of any one of embodiments 1-8, wherein the plurality of electrochemical cell layers includes three or more electrochemical cell layers.

Embodiment 10: The electrochemical cell stack of any one of embodiments 1-9, wherein the plurality of bundle assemblies includes three or more bundle assemblies.

Embodiment 11: The electrochemical cell stack of any one of embodiments 1-10, further comprising DC electronics electrically connected to one or more bundle assemblies.

Embodiment 12: The electrochemical cell stack of embodiment 11, wherein the DC electronics regulate current along one or more edges of the one or more bundle assemblies.

Embodiment 13: The electrochemical cell stack of any one of embodiments 1-12, further comprising one or more stiffening elements disposed between two of the plurality of bundle assemblies.

Embodiment 14: The electrochemical cell stack of any one of embodiments 1-13, further comprising one or more shims disposed between two of the plurality of bundle assemblies.

Embodiment 15: A bundle assembly for use in an electrochemical cell stack comprising:
a top bundle plate,
a bottom bundle plate, and
a plurality of electrochemical cell layers disposed between the top bundle plate and the bottom bundle plate,
wherein the plurality of electrochemical cell layers is electrically and fluidly connected to the top bundle plate and the bottom bundle plate.

Embodiment 16: The bundle assembly of embodiment 15, wherein the top bundle plate and the bottom bundle plate each include one or more latching features.

Embodiment 17: The bundle assembly of embodiment 16, wherein the one or more latching features are reversibly attachable to the top bundle plate and the bottom bundle plate.

Embodiment 18: The bundle assembly of any one of embodiments 15-17, further comprising one or more plenum hydration plugs.

Embodiment 19: The bundle assembly of any one of embodiments 15-18, wherein the top bundle plate and the bottom bundle plate each further include one or more alignment features to align the bundle assembly in an electrochemical cell stack.

Embodiment 20: The bundle assembly of any one of embodiments 15-19, further comprising a venting feature, a draining feature, or both.

Embodiment 21: The bundle assembly of any one of embodiments 15-20, wherein the top bundle plate, the bottom bundle plate, or both further include edge current carrying features.

Embodiment 22: The bundle assembly of embodiment 21, further comprising a busbar attached to the edge current carrying features.

Embodiment 23: The bundle assembly of any one of embodiments 15-22, wherein the top bundle plate, the bottom bundle plate, or both further include one or more stiffening elements.

Embodiment 24: A process for building an electrochemical cell stack comprising:
manufacturing a bundle assembly, the bundle assembly comprising:
   a top bundle plate,
   a bottom bundle plate, and
   a plurality of electrochemical cell layers disposed between the top bundle plate and the bottom bundle plate, and
   wherein the plurality of electrochemical cell layers is electrically and fluidly connected to the top bundle plate and the bottom bundle plate;
connecting two or more bundle assemblies to form the electrochemical cell stack.

Embodiment 25: The process of embodiment 24, further comprising compressing the bundle assembly before the connecting step.

Embodiment 26: The process of embodiment 25, further comprising applying a latch to latching features located on the top bundle plate and the bottom bundle plate to maintain a compressive force on the bundle assembly.

Embodiment 27: The process of any one of embodiments 24-26, further comprising testing the bundle assembly before the connecting step.

Embodiment 28: The process of embodiment 27, wherein the testing includes mechanical testing, electrical testing, leak testing, or a combination thereof.

Embodiment 29: The process of any one of embodiments 24-28, further comprising hydrating the bundle assembly.

Embodiment 30: The process of any one of embodiments 24-29, wherein the connecting step is performed while the bundle assemblies are submerged underwater.

1. An electrochemical cell stack comprising:
a first end cap assembly;
a plurality of bundle assemblies, each bundle assembly including:
a top bundle plate,
a bottom bundle plate, and
a plurality of electrochemical cell layers disposed between the top bundle plate and the bottom bundle plate, and
wherein the plurality of electrochemical cell layers is electrically and fluidly connected to the top bundle plate and the bottom bundle plate; and
a second end cap assembly,
wherein each bundle assembly in the plurality of electrochemical cell layers is independently removable from the electrochemical cell stack,
wherein the plurality of bundle assemblies is disposed between the first end cap assembly and the second end cap assembly, and
wherein the plurality of bundle assemblies is electrically and fluidly connected to the first end cap assembly and the second end cap assembly.

2. (canceled)

3. The electrochemical cell stack of claim 1, wherein each electrochemical cell layer is electrically isolated.

4. The electrochemical cell stack of claim 1, wherein each electrochemical cell layer includes a proton exchange membrane, an anion exchange membrane, a membrane for alkaline electrolysis, or a membrane for solid oxide electrolysis.

5. The electrochemical cell stack of claim 1, further comprising one or more compression features attached to the first end cap assembly and the second end cap assembly to hold the electrochemical cell stack under compression.

6. The electrochemical cell stack of claim 5, wherein the compression features include tie rods.

7. The electrochemical cell stack of claim 1, wherein each top bundle plate and each bottom bundle plate further include one or more alignment features to align the bundle assembly in the electrochemical cell stack.

8. The electrochemical cell stack of claim 1, wherein the electrochemical cell stack is an electrolyzer stack, a fuel cell stack, or an electrochemical compression cell stack.

9. The electrochemical cell stack of claim 1, wherein the plurality of electrochemical cell layers includes three or more electrochemical cell layers.

10. The electrochemical cell stack of claim 1, wherein the plurality of bundle assemblies includes three or more bundle assemblies.

11. The electrochemical cell stack of claim 1, further comprising DC electronics electrically connected to one or more bundle assemblies.

12. The electrochemical cell stack of claim 11, wherein the DC electronics regulate current along one or more edges of the one or more bundle assemblies.

13. The electrochemical cell stack of claim 1, further comprising one or more stiffening elements disposed between two of the plurality of bundle assemblies.

14. The electrochemical cell stack of claim 1, further comprising one or more shims disposed between two of the plurality of bundle assemblies.

15. A bundle assembly for use in an electrochemical cell stack comprising:
a top bundle plate,
a bottom bundle plate, and
a plurality of electrochemical cell layers disposed between the top bundle plate and the bottom bundle plate,
wherein the plurality of electrochemical cell layers is electrically and fluidly connected to the top bundle plate and the bottom bundle plate, and
wherein the top bundle plate and the bottom bundle plate each further include one or more alignment features to align the bundle assembly in an electrochemical cell stack.

16. The bundle assembly of claim 15, wherein the top bundle plate and the bottom bundle plate each include one or more latching features.

17. The bundle assembly of claim 16, wherein the one or more latching features are reversibly attachable to the top bundle plate and the bottom bundle plate.

18. The bundle assembly of claim 15, further comprising one or more plenum hydration plugs.

19. (canceled)

20. The bundle assembly of claim 15, further comprising a venting feature, a draining feature, or both.

21. The bundle assembly of claim 15, wherein the top bundle plate, the bottom bundle plate, or both further include edge current carrying features.

22. The bundle assembly of claim 21, further comprising a busbar attached to the edge current carrying features.

23. The bundle assembly of claim 15, wherein the top bundle plate, the bottom bundle plate, or both further include one or more stiffening elements.

24. A process for building an electrochemical cell stack comprising:
manufacturing a bundle assembly, the bundle assembly comprising:
a top bundle plate,
a bottom bundle plate, and
a plurality of electrochemical cell layers disposed between the top bundle plate and the bottom bundle plate, and
wherein the plurality of electrochemical cell layers is electrically and fluidly connected to the top bundle plate and the bottom bundle plate;
connecting two or more bundle assemblies to form the electrochemical cell stack.

25. The process of claim 24, further comprising compressing the bundle assembly before the connecting step.

26. The process of claim 25, further comprising applying a latch to latching features located on the top bundle plate and the bottom bundle plate to maintain a compressive force on the bundle assembly.

27. The process of claim 24, further comprising testing the bundle assembly before the connecting step.

28. The process of claim 27, wherein the testing includes mechanical testing, electrical testing, leak testing, or a combination thereof.

29. The process of claim 24, further comprising hydrating the bundle assembly.

30. The process of claim 24, wherein the connecting step is performed while the bundle assemblies are submerged underwater.
